(19) United States
(12) Patent Application Publication
(10) Pub. No.: US 2009/0165252 A1
(43) Pub. Date: Jul. 2, 2009

(54) Hinge Assembly

(76) Inventor: Jr-Jiun Chern, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/967,294

(22) Filed: Dec. 31, 2007

(51) Int. Cl. E05D 5/10

(52) U.S. Cl. 16/386

(57) ABSTRACT

A hinge assembly comprises a pintle for pivotally receiving a first coupling member, a positioning member, a second coupling member, a positioning limiting device and a first friction device. The first coupling member includes a side having a projection, and a supporting portion having two wings. The second coupling member includes a protuberance adapted to be rotated to abut against the projection for stopping movement of the second coupling member with respect to the first coupling member. The positioning limiting device includes a first member and a second member. The first member rests on the supporting portion and includes two compartments receiving two wings respectively and a block. The second member has an engagement surface adapted to be rotated to abut against the block, for stopping movement of the second coupling member with respect to the first coupling member. The first friction device is biasably moved by the positioning member.

### BACKGROUND OF THE INVENTION

1. Field of the Invention

The present invention relates to a hinge assembly, in particular to a hinge assembly that can be used to support a relatively heavy hinged member.

2. Description of the Related Art

Referring to U.S. PUB. APP. No. 2004/0025298, a hinge that can be used with a notebook computer or the like includes an assembly board 30 having a guide plate 31 and a locking portion 33 defined thereon, and a baffle 42 having a projective portion 46 locked onto the locking portion 33 of the guide plate 31 to limit the rotation angle of the assembly board 30 on the small-diameter rod 12. Unfortunately, if the notebook has a heavy display or if the display is equipped with other accessories, such as a web cam, a mini loudspeaker, an antenna, and others, the baffle 42 is liable to distortion due to not sturdy enough to support these weights and further loses its original tightness to maintain the desired resistance consequently.

The present invention is, therefore, intended to obviate or at least alleviate the problems encountered in the prior art.

### SUMMARY OF THE INVENTION

It is therefore an object of the present invention to provide a hinge assembly that prevents distortion of its components under relatively high loading condition.

Accordingly, the hinge assembly comprises a pintle for pivotally receiving a first coupling member, a positioning member, a second coupling member, a positioning limiting device and a first friction device. The first coupling member includes a side having a projection, and a supporting portion having two wings. The second coupling member includes a protuberance adapted to be rotated to abut against the projection for stopping movement of the second coupling member with respect to the first coupling member. The positioning limiting device includes a first member and a second member. The first member rests on the supporting portion and includes two compartments receiving two wings respectively and a block. The second member has an engagement surface adapted to be rotated to abut against the block, for stopping movement of the second coupling member with respect to the first coupling member. The first friction device is biasably moved by the positioning member.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a hinge assembly in accordance with the present invention.

FIG. 2 is an exploded perspective view of the hinge assembly.

FIG. 3 is a front elevation view of the hinge assembly shown in FIG. 1

FIG. 4 is a cross-sectional view taken along line 4-4 of FIG. 3.

FIG. 5 is a cross-sectional view taken along line 5-5 of FIG. 3.

FIG. 6 is similar to FIG. 4, but shows the hinge assembly with the first coupling member in another position relative to the second coupling member.

FIG. 7 is similar to FIG. 5, but shows the hinge assembly with the first coupling member in another position relative to the second coupling member.

### DETAILED DESCRIPTION OF THE PREFERRED EMBODIMENT

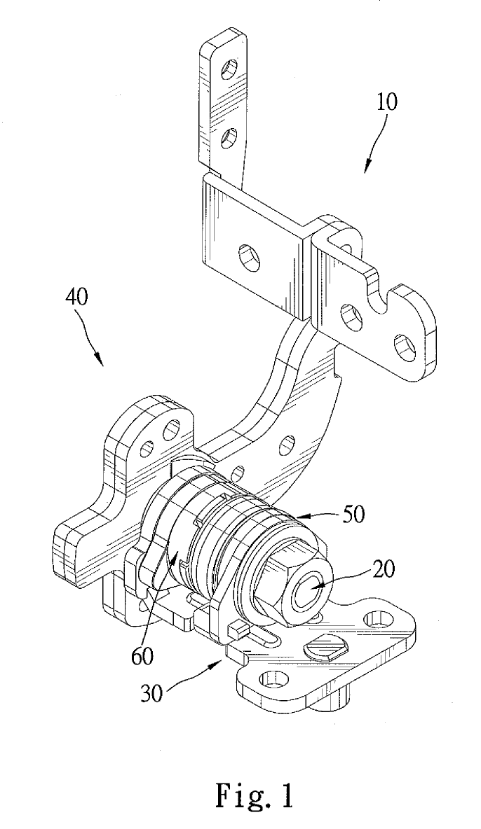

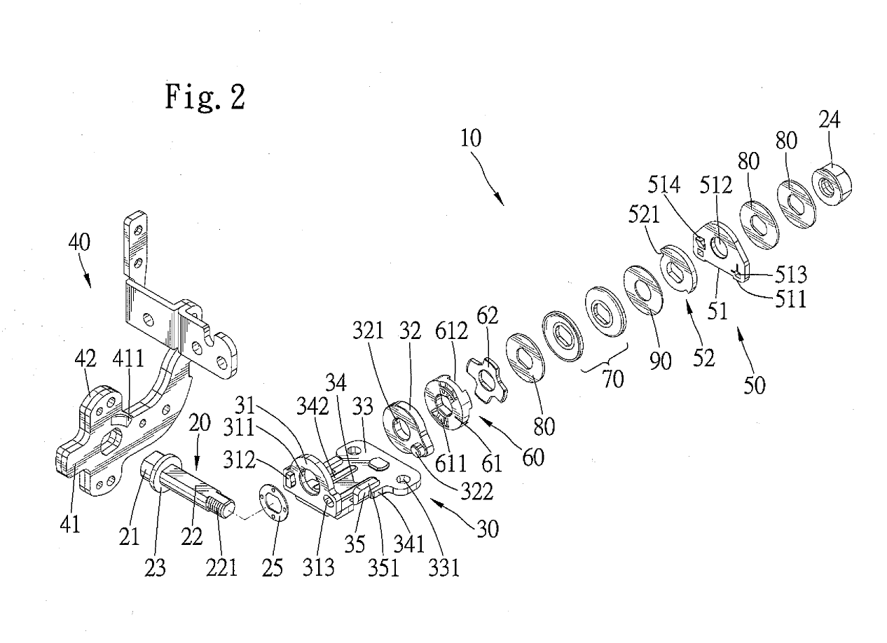

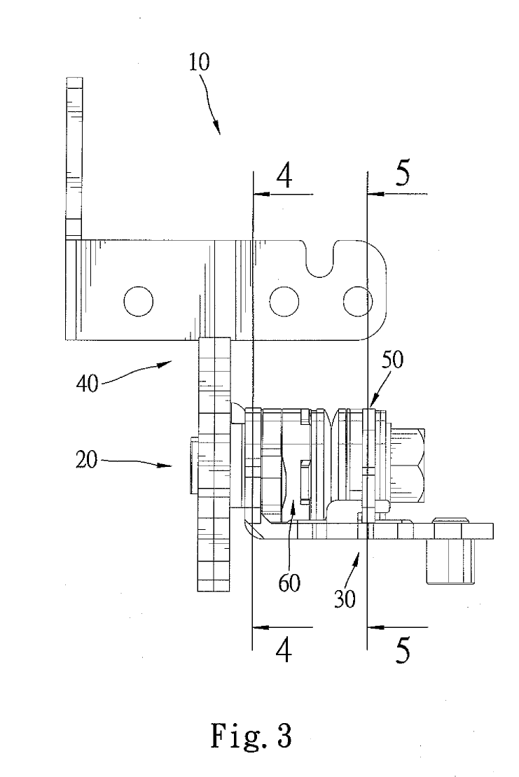

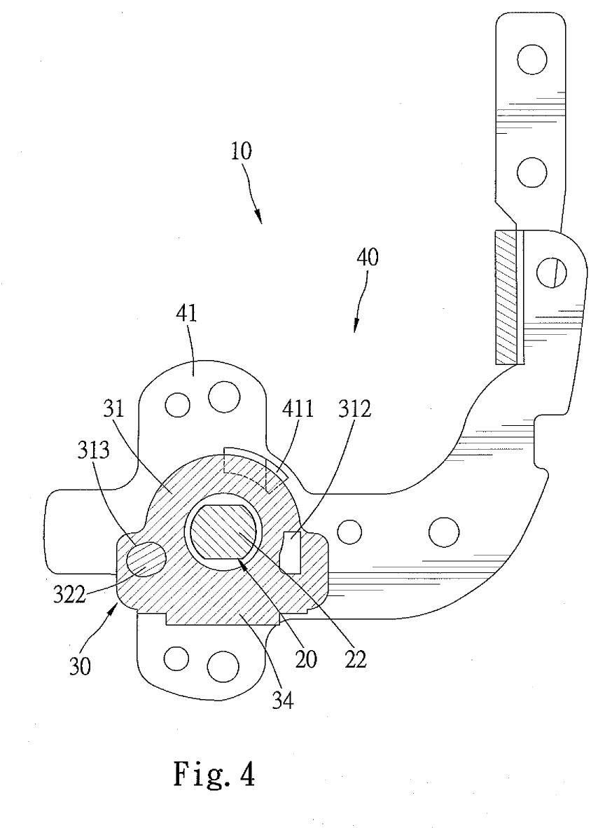

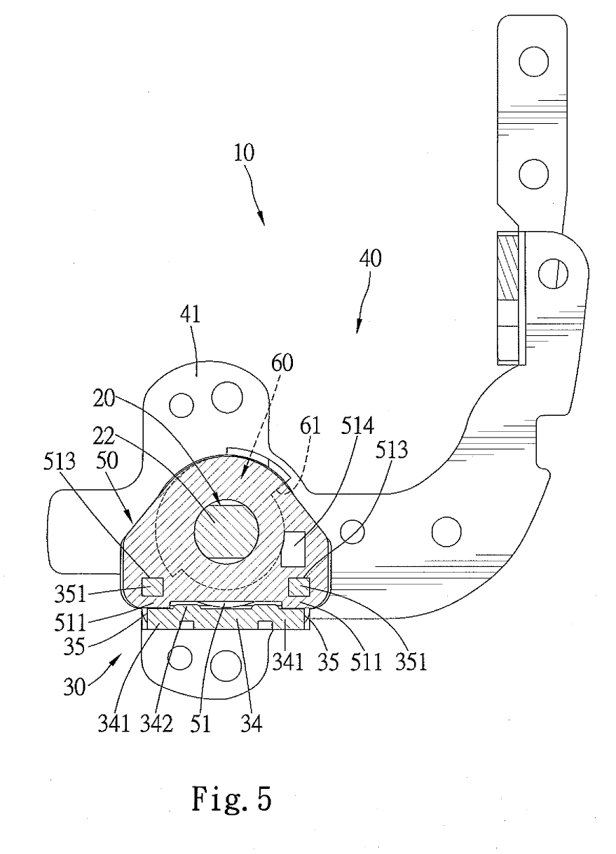

Referring to FIGS. 1 through 5, a hinge assembly 10 that can be used to support a relatively heavy hinged member includes a pintle 20 having a first and a second section 21, 22 and a shoulder 23 formed therebetween. A second coupling member 40, which is adapted to connect to a cover of a notebook computer and the like, is pivotally received on the first section 21. A first coupling member 30, a positioning member 32, a position-limiting device 50, a first friction device 60, a second friction device 70 and a plurality of washers 80 are pivotally received on the second section 22, which includes an end portion 221 having threaded sides for threadly engaging with an end cap 24. Therefore, the aforementioned elements 30, 32, 50, 60, 70, 80 are retained between the shoulder 23 and the end cap 24 on the second portion 22.

The first coupling member 30 includes a side 31 and a base (not numbered) extended in an angled relation. Preferably, the base extends at a 90-degree angle in relation to the side 31. The side 31 includes an orifice 311 which permits the pintle 20 inserted through to rotate with respect to the first coupling member 30. A projection 312 and an aperture 313 are also defined on the side 31. The base includes a coupling portion 33, which is adapted to connect to a manual input device housing of a notebook computer and the like. In this embodiment, the coupling portion 33 has a plurality of engagement holes 331 for allowing fasteners which connect the coupling portion 33 to the housing to be inserted. The base further includes a supporting portion 34 disposed between the side 31 and the coupling portion 33, and on which formed two wings 35 which extend from two opposed edges thereof respectively and are symmetrically disposed with respect to the supporting portion 34, two support surfaces 341 which extend from the two opposed edges respectively, and two support ribs 342 which traversely extend and are disposed adjacent to two wings 35 respectively for reinforcing the structure of the support portion 34. In addition, each wing 35 includes a L-shaped hook portion 351 in an angled relation with respect to the supporting portion 34. Preferably, the wing 35 and the supporting portion 34 have a substantially 90-degree angled relation. The L-shaped hook portion 351 has a first leg (not numbered) extending upward from the supporting portion 34 and a second leg (not numbered) therefrom parallel to the supporting portion 34.

Furthermore, a friction-reducing member 25 is disposed between the shoulder 23 of the pintle 20 and a surface of the side 31 from which the projection 312 extends.

The positioning member 32 includes a hole 321 through which the second section 22 of the pintle 20 inserts, and a stub 322 which engages in the aperture 313. Thus, the positioning member 32 can pivot in concert with the first coupling member 30 relative to the pintle 20.

The second coupling member 40 includes a first and a second arm 41, 42 overlapped to one anther, and the arms 41, 42 are pivotally connected to the first section 21 of the pintle 20. Moreover, the first arm 41 includes a monolithically formed protuberance 411 thereon and is disposed close to the first coupling member 30.

The positioning-limiting device 50 includes a first member 51 having two foot portions 511 supported by the two support surfaces 341 respectively, a hole 512 through which the second section 22 of the pintle 20 inserts, two compartments 513 which receive the second legs of the corresponding hook portions 351 respectively, and a block 514 is formed on a surface thereof. The positioning-limiting device 50 further includes a second member 52 having a first and a second arcuate peripheral edge, and an engagement surface 521 interconnecting the first and second peripheral edges. The engagement surface 521 extends radially outwards from the first peripheral edge to the second peripheral edge.

The first friction device 60 includes a rotating member 61 having a surface on which formed a plurality of fanwise portions 611, each of which is disposed at a different radial distance with respect to the center thereof and is adapted to be rotated relative to the positioning member 32 to complemently receive an associated ridge (not shown) disposed thereon. Therefore, the first friction device 60 is biasably moved by rotating the ridges in and out of the associated fanwise portions 611. The first friction device 60 further includes another surface 612 on which a resilient member 62 is to be mounted. The resilient member 62 is formed with four claws extended from the peripheral edge thereof.

The second friction device 70 includes a plurality of disc-shaped springs and is disposed between the position-limiting device 50 and the first friction device 60.

The washers 80 may be placed between the position-limiting device 50 and the second friction device 70 and the first and the second friction devices 60, 70 respectively.

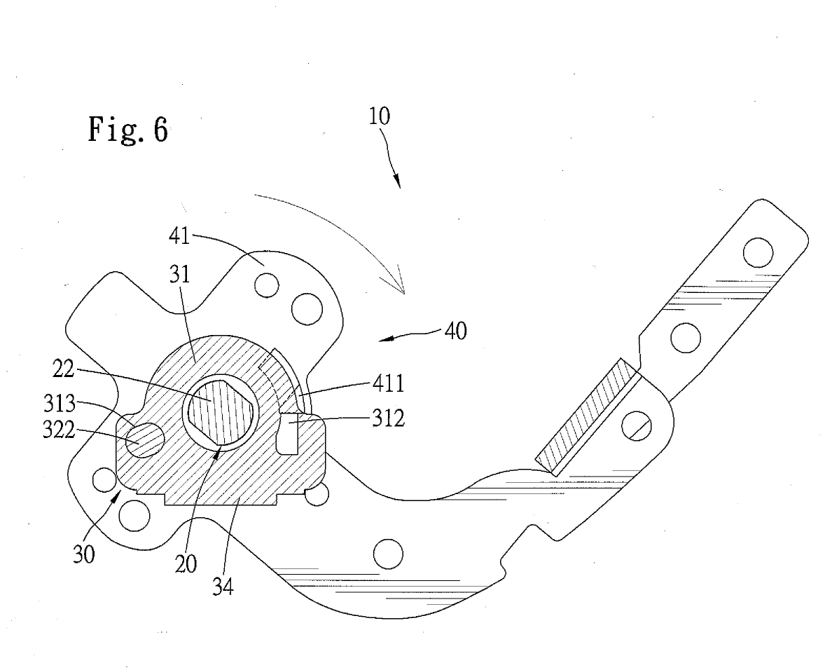

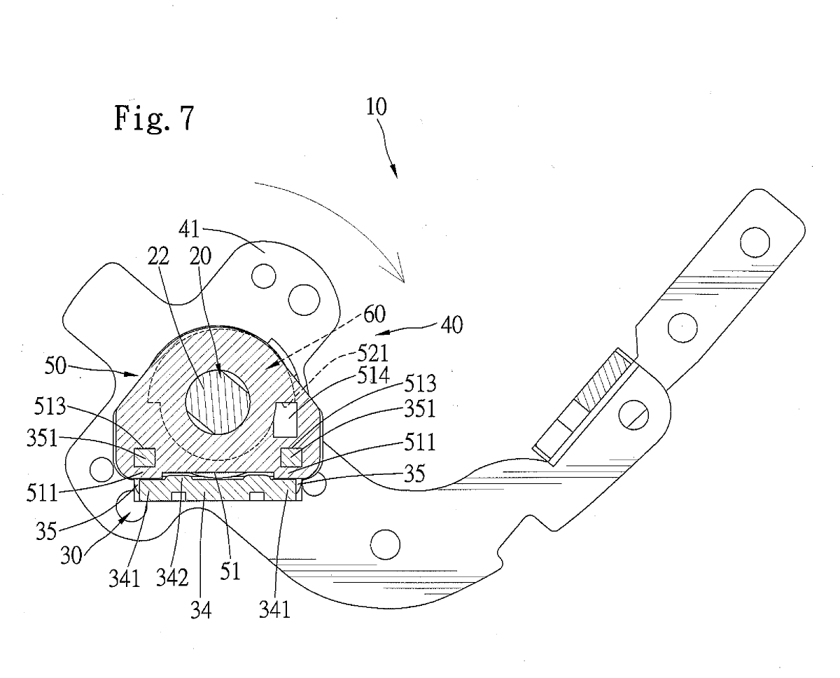

Referring to FIGS. 6 and 7, the second coupling member 40 is adapted to be rotated relative to the first coupling member 30 and be stopped until the protuberance 411 abuts against the projection 312, and the engagement surface 521 of the second member 52 of the position-limiting device 50 abuts against the block 514 of the first member 51 of the position-limiting device 50. As such, the second coupling member 40 can be prevented from further rotational movement relative to the first coupling member 30 in an arrow-indicated direction.

One aspect of the present invention is that forces existed between the contacted protuberance 411 and projection 312 and the contacted engagement surface 521 and block 514 can be transmitted to supporting portion 34 of the first coupling member 30 for preventing distortion of components of the hinge assembly 10 under relatively high loading condition. Furthermore, the positioning member 32 can cause the first friction device 60 to be biasably moved, causing the resilient member 62 and the second friction device 70 to provide for resistance force between first and second coupling members 30, 40.

While the specific embodiments have been illustrated and described, numerous modifications come to mind without significantly departing from the spirit of invention and the scope of invention is only limited by the scope of accompanying claims.

1. A hinge assembly comprising:
a pintle including a first section and a second section;
a first coupling member including a side pivotally connected to the second section of the pintle and a supporting portion having two wings disposed at two edges thereof respectively, with the supporting portion being generally perpendicular to the side, with a projection formed on the side;
a positioning member pivotally connected to the second section of the pintle and connected to the side of the first coupling member;
a second coupling member pivotally connected to the first section of the pintle and rotatable with respect to the first coupling member, with the second coupling member including a protuberance rotated to abut against the projection for stopping movement of the second coupling member with respect to the first coupling member;
a positioning limiting device pivotally connected to the second section of the pintle and including a first member and a second member, with the first member connected to the two wings, with the first member having two foot portions contacted against the supporting portion of the first coupling member, with the first member further having a block, with the second member having an engagement surface rotated to abut against the block for stopping movement of the second coupling member with respect to the first coupling member; and
a first friction device pivotally connected to the second section of the pintle and biased to move by the positioning member.

2. The hinge assembly as claimed in claim 5 wherein each wing comprises a hook portion, and wherein the first member of the positioning limiting device comprises a compartment receiving the hook portion.

3. The hinge assembly as claimed in claim 2 wherein the supporting portion comprises two support surfaces which extend from the two opposed edges respectively and supports the two foot portions.

4. The hinge assembly as claimed in claim 3 wherein the hooking portions are symmetrically disposed with respect to the supporting portion, and each hooking portion comprises a first leg extending upward from the supporting portion and a second leg extending from the first leg and parallel to the supporting portion.

5. The hinge assembly as claimed in claim 1 wherein the supporting portion comprises two support ribs extending generally perpendicular to the first side and for reinforcing the support portion, with the two support ribs located intermediate the two foot portions.

6. The hinge assembly as claimed in claim 5 wherein the second coupling member comprises a first arm and a second arm overlapping one another, and wherein the protuberance is monolithically formed on the first arm.

7. The hinge assembly as claimed in claim 5 wherein the first friction device comprises a rotating member having a surface on which a plurality of fanwise portions disposed at a different radial distance wit respect to a center thereof is formed.

8. The hinge assembly as claimed in claim 7 further comprising a resilient member formed with four claws extended from a peripheral edge thereof and tush disposed on the surface of the first friction device.

9. The hinge assembly as claimed in claim 5 wherein the side comprises an aperture, and wherein the positioning member comprises a stub received in the aperture.

10. The hinge assembly as claimed in claim 5 further comprising a second friction device disposed between the position-limiting device and the first friction device.
